(19) United States
(12) Patent Application Publication
(10) Pub. No.: US 2010/0230842 A1
(43) Pub. Date: Sep. 16, 2010

(54) Snow block apparatus

(76) Inventor: James C. Pendergast, Racine, WI (US)

Correspondence Address: DENNIS A. GROSS;D|B|A THE HILL FIRM, 666 DUNDEE RD, SUITE 1201, NORTHBROOK, IL, 60062, US

(21) Appl. No.: 12/657,413

(22) Filed: Jan. 20, 2010

Related U.S. Application Data
(63) Continuation-in-part of application No. 12/381,397, filed on Mar. 11, 2009.

(51) Int. Cl. E04B 1/28; B29C 39/36

(52) U.S. Cl. 264/33; 249/66.1

(57) ABSTRACT

A four-sided open top forming mold body for material such as snow or sand having peripheral walls with in-turned flanges at a bottom thereof, a mold bottom adapted to rest against the in-turned flanges, inter-engaging edge portions of the bottom and configurations on the walls retaining the bottom in place until application of a force sufficient to overcome the retention whereby the bottom can push the molded material out of the mold, and the bottom can be re-snapped into position at the bottom before another material molding, the mold body adapted to receive an open ended receptacle such as a sandbag having a greater length than the height of the mold such that the receptacle open end can be closed when the receptacle is filled with material to the top of the mold.

### RELATED CASE

This application is a continuation-in-part of Ser. No. 12/381,397 filed Mar. 11, 2009.

### BACKGROUND OF THE INVENTION

1. Field of the Invention

This invention relates to molds and more particularly to a mold for use in forming snow blocks.

2. General Background

It is common for children and adults in those parts of the world having heavy snowfall or beaches to form structures from the snow or wet sand. Oftentimes such structures are formed from blocks or other shapes that have been formed by compressing the snow or wet sand into a container such that the compressed material takes on the shape of the interior of the container. Numerous examples of such molding systems exist, such as shown, for example in U.S. Pat. No. 3,685,942 where the molding member is formed as a scoop, or U.S. Pat. No. 2,752,631 where the molding member is formed as part of a snow shovel or U.S. Pat. No. 3,713,431, where the molding member is formed of a four-sided housing and an L-shaped scoop and compressor, which interfits with the housing to form the block or the five-sided mold of U.S. Pat. No. D246,664. Many means of extraction of a formed block have been proposed, such as the ejector shown in U.S. Pat. No. 3,859,029 or the strap shown in U.S. Pat. No. 3,848,846.

While such molding systems assist in providing shaped snow, sand or other loose granular material blocks, and address, in differing designs, one or more of approaches to a snow or sand molding form, however each design has deficiencies associated therewith, which are overcome with the present invention.

While it is well known to use molded snow blocks in the construction of walls and other structures such as igloos and snow forts, there is another and more important use for temporary structures and walls utilizing, generally, sand. Levy extensions or floodwalls for containing flood waters are needed substantially every year. Such walls and structures are normally built of sandbags where, when sand, generally wet sand, has been shoveled into the open top of a fabric or heavy paper bag, which are then laid sideways one on top of each other to build up a barrier.

Since it is desired that the bag form a layer upon which other bags can be stacked, it is necessary that the bag or other container be filled to less than its total capacity and then closed off at the open end. Carrying the bag from the closed off open end results of course in the material in it agglomerating at the bottom of the bag, and the bag must therefore be reshaped into a slab-like condition at the point of use. Underfilling of the bag creates a bag that does not form a proper height layer for the next series of bags to be placed on it, whereas overfilling the bag can produce a bulging situation.

Another frequent use for sand bag walls, whether utilizing sand, dirt, gravel or other loose material readily available, are military blast resistant walls or bullet resistant walls or reventments. Such walls or reventments are often used to protect temporary gun placements, to provide protection for observation and inspection stations, and to provide added protection to buildings and other facilities. In such military grade constructions it is important that the wall be constructed of generally identically filled bags so that as the structure is built up the various layers are generally self stabilizing with respect to lower layers. The ability of the bags to deform slightly to accommodate differing terrain features or to accommodate slightly different positioning with respect to other bags is a plus feature for such temporary structures.

In the emergency conditions normally surrounding the use of sandbags, proper filling technique, which will differ according to the condition of and the type of material filling the bag, is important to the provision of an adequate barrier. Unfortunately the conditions under which sandbags are utilized are not conducive to measured filling and the repetitive filling of substantially equally dimensioned bags.

Another disadvantage of currently utilized manual filling systems for sandbags is that the bag must be tied off at one end, usually resulting in either a knot of bag material at the end or an excess of bag material at the end. To that extent, the bags are then placed side by side with an end in contact with an adjacent bag, gapping can occur, which is compounded by the fact that the bags in handling are often simply grabbed from the tied off end so that the material bunches at the other end of the bag.

The deficiencies in existing manual filling techniques for sandbags are overcome, according to this invention, in substantially the same manner as provided for the formation of snow blocks or sand blocks, although in addition utilizing bags or liners or other containers.

### SUMMARY OF THE INVENTION

The present invention provides a forming mold for molding snow, sand or other loose granular material into a block shape generally conforming to the interior dimensions of the mold. The mold body is preferably provided with sidewalls having an initial upward and outward taper to facilitate funneling of material into the mold body or into a liner or bag received in the mold body, a secondary taper adjacent an open top of the mold body may be provided to facilitate release of the packed material or liner bag from the mold body. In an embodiment, a down-turned exterior skirt spaced from the sidewall of the mold extending downwardly from adjacent the top of the sidewalls can provide a gripping surface for lifting the mold but can also functions as a protected attachment point for a bail with the free ends of the bail residing between the sidewall and the downwardly extending outer flange.

In an embodiment, the mold sidewalls terminate at their end opposite the open top end in an in-turned flange, which provides support for a removable bottom. Internal surface interruptions which may be a projecting bead or a series of projecting beads or a series of wall recesses are formed on the interior of the sidewalls and cooperate with the bottom's edge to hold the bottom removably in place. The beads are preferably spaced from an upper surface of the in-turned flange by a dimension approximately equal to the thickness of the removable bottom or when using a recess starting generally adjacent the upper surface of the flange which recesses will receive tab-like projections on the outer edge of the bottom, whereby the bottom can be snapped into place between the bead and the flange or generally at the flange when the bottom is provided with projecting peripheral tabs insertable into the sidewall recess.

The bottom may be provided with openings therethrough allowing for drainage of water during the snow compaction process, the openings also provided for easy gripping of the bottom by a user's fingers. If desired, a secondary cover may be provided to fit within the flared section of the upper portion of the sidewalls to assist in compacting the material into the mold, however such an additional top piece is supplemental since children or others using the mold can easily push the material into shape with their hands.

When the mold formed material is desired to be used in a more critical environment, such as for flood protection, blast protection or personnel protection, the mold will preferably be used with a bag into which the sand, dirt or other loose granular material will be shoveled, poured or placed while the bag is in the mold. To this end, the bag is preferably formed to fit into the mold in general conformity to the dimensions of the mold, and preferably forms a generally flat bottom and ideally the bag has an open top designed to be folded over to form a closed bag top basically at the top of the mold form. Whether the bag is made of paper, burlap, polypropylene or the like, it may be preformed to have a somewhat flat bottom and to be able to assume a generally rectangular section above the flat bottom. The bag will have a dimension greater than the depth of the mold sufficient to provide material at the top to be folded over on top of the material contained in the bag while still in the mold. In this manner the bag and its contents can be laid in place by inverting the mold over the position where the bag and its contents are to be utilized. The fold folded over top will then rest on the underside, where it will be in engagement either with a ground surface or with another layer of bags, such that material will not fall from the bag.

When it is desired then to dismantle the structure formed by the sandbags, merely holding the bag upside down with the folded over portion on the bottom but elevated above a surface will allow the bag to open and the contents to be discharged. It will be appreciated that as used herein, the term “sandbag” is to be considered generic of the types of containers described herein, whether or not it is formed of bag material such as discussed above or other material, for example a more rigid sleeve material with living hinge top sections.

It is therefore an object of this invention to overcome deficiencies in prior art snow molds and to provide a simple, easily constructed, inexpensive snow mold.

In an embodiment of the invention the snow mold comprises a four-sided mold member having an in-turned flange at the bottom of the sidewalls, a removable bottom member received against the in-turned flange and held in place thereagainst by interference fit projections on an interior surface of at least some of the sidewalls spaced above the in-turned flange.

In another embodiment of the invention the mold comprises an at least four-sided member having at least one in-turned flange at a bottom of the sidewall and a removable bottom member insertable into the mold member from an open top thereof against the in-turned flange, at least some of the sidewall provided with surface features which engage with edge adjacent features of the boundary edges of the bottom member to removably hold the bottom member in position in juxtaposition to the flange.

In an embodiment of the invention the mold consists of a generally rectangular open top and bottom enclosure adopted to receive a liner or bag, the mold having an in-turned flange at a bottom of its sidewalls on at least two opposing walls, a removable bottom member dimensioned to be received at the bottom of the sidewalls supported by the flange, the sidewalls and edges of the removable bottom having complimentary surfaces adapted to removably snap lock the bottom in position with respect to the flange upper surfaces and the sidewalls preventing accidental displacement of the bottom but allowing intentional removal of the bottom, the liner or bag, in its open position substantially filling the mold interior.

In a further embodiment of the invention, the mold consists of a generally rectangular multi-sided mold body open at a top and a bottom of a mold interior defined by mold sidewalls, at least two of the non-adjacent sidewalls having an in-turned flange for at least a portion of the sidewall at a bottom thereof to support and prevent removal through the bottom of the mold body of a removable bottom member insertable through the open top and against the flange, at least two non-adjacent sidewalls having additional surface features spaced from or adjacent to the top of the flange and engageable with edge or surface features of the removable bottom in a snap-together fashion to retain the bottom against accidental release through the top while allowing intentional displacement of the bottom.

In a further embodiment of the invention, the mold consists of at least at four-sided main mold body defined by sidewalls having tops and bottoms, at least one of the sidewalls at the top being flared outwardly with respect to remaining portions of the sidewalls and terminating in a downwardly extending skirt spaced from the sidewall, the mold being provided with a removable bottom conforming to the interior dimensions of the sidewalls adjacent a bottom thereof.

In an embodiment of the invention, a mold body is provided having a plurality of sidewalls forming an enclosure, the sidewalls having bottoms forming in-turned flanges leaving a portion of the bottom of the enclosure open, a removable bottom plate is insertable into the body against the in-turned flanges, bottom engageable reeleaseable means are formed on the inside surfaces of at least some of the sidewalls effective to hold the bottom against the flange but to allow the bottom to snap out of position to be pushed through the top of the mold body thereby pushing the contents of the mold from the enclosure, the bottom being provided with drainage openings therethrough.

In an embodiment of this invention, a method of filling sand bags is provided which comprises the steps of providing a multi-sided mold body comprised of sidewalls, at least some of which terminate at a bottom in an in-turned flange, and the sidewalls form an enclosure, a removable bottom being receivable through an open top of the enclosure and having an interference fit relationship with sidewall features adjacent the in-turned flanges to allow the bottom to be snapped into position and held therein until application of a removal force from the bottom sufficient to separate the bottom from the sidewalls, a sand bag adapted to be received in the mold body enclosure, the sand bag having an extension extending above the sidewalls when the sand bag is bottomed against the removable bottom whereby the open top of the sand bag at the extension can be folded over after the sand bag has been filled with material to a top level of the mold, the fold over to be sufficient to retain the material in the sand bag when the sand bag is placed in an inverted position and the mold is removed from the sand bag.

In an embodiment of the invention a mold body is provided comprising a multi-sided enclosure defined by sidewalls forming an open top and open bottom closure, at least portions of non-adjacent sidewalls having in-turned flanges at their bottoms, a removable bottom insertable into the interior of the enclosure against the in-turned flanges, interference fit projections cooperating between at least some of the sidewalls and the bottom to retain the bottom against the flange in a snap fit connection with the bottom being removable by applying a force upwardly towards the open top of the mold body, the mold body containing a sand bag dimensioned to substantially fill the enclosure while lying against the bottom and having a bag height to an open top sufficiently greater than the height of the sidewalls to allow the bag top to be folded over or to be tied or cinched closed at approximately the height of the mold body whereby upon inversion of the mold the sand bag can be ejected with the fold over, tied or cinched portion lying on the bottom against the surface and the bag can be ejected from the mold body by pushing against the bottom wall to release it from its position against the flanges.

It is an overall general object of this invention to provide an improved inexpensive mold performing blocks of compactable or granular material either as a material only block or as a material contained in a bag block, where the mold forming body consists of a multi-sided enclosure formed by upstanding sidewalls, the mold having an open top and a removable bottom held in place against in-turned flange portions of at least some of the sidewalls and snap fit surface interruption features complementary between the sidewalls and an edge of the removable bottom.

It is therefore a general object of this invention to provide an improved snow mold for use in molding snow into blocks or other shaped three-dimensional solid or semi-solid forms and to provide for easy removability of the formed shape from the mold. This and other objects will be apparent to those of ordinary skill in the art from the description of the preferred embodiment and giving reference to the accompanying drawings.

### BRIEF DESCRIPTION OF THE DRAWINGS

FIG. 1 is a perspective view of the mold according to this invention showing the bottom positioned outside of the mold body.

FIG. 2 is an enlarged cross-section view generally along the lines ii-ii of FIG. 1.

FIG. 3 is a perceptive view similar to FIG. 1 showing a modified mold.

FIG. 4 is a cross-sectional view being generally along the lines of 4-4 of FIG. 3 but with the bottom snapped in place.

FIG. 5 is a view of the mold of FIG. 3 with a semi-rigid insert having a fold over open top.

FIG. 6 is a perspective exploded view of a further modification of the mold having a different bail and attachment and stiffening ribs.

FIG. 7 is a cross-sectional view taken generally along the lines 7-7 of FIG. 6.

FIG. 8 is a view of the mold of FIG. 7 with a bag liner formed from a gusseted bag.

FIG. 9 is a perspective view of a modified mold.

FIG. 10 is a cross section taken generally along the lines of 10-10 of FIG. 9.

FIG. 11 is an elevated perspective view of a wall and corner formed using the mold of this invention.

### DESCRIPTION OF THE PREFERRED EMBODIMENT

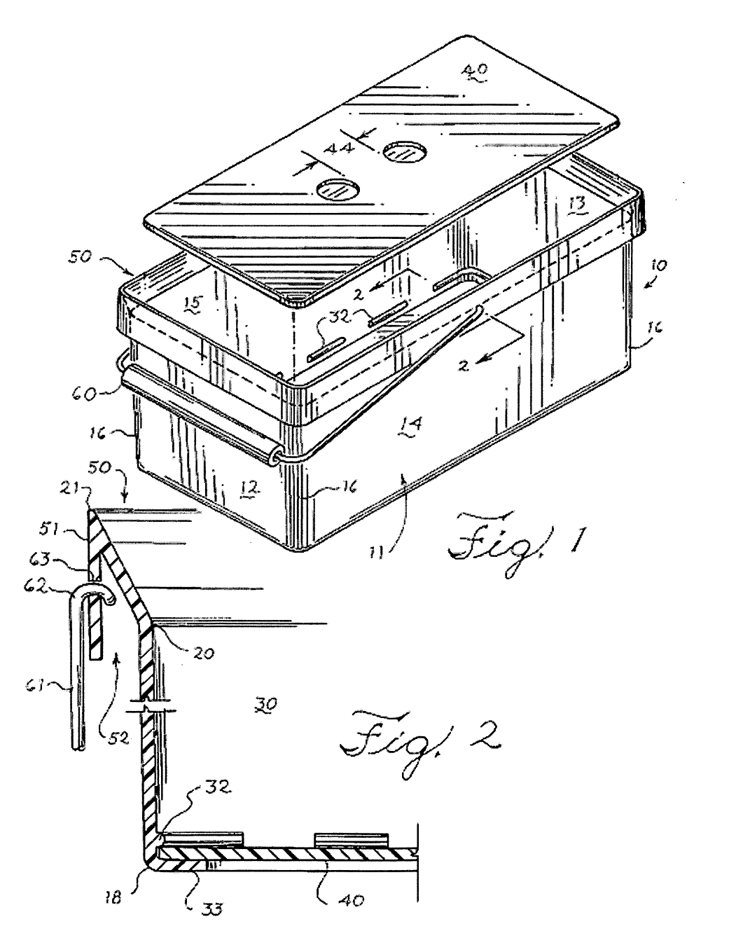

As shown in FIG. 1, the apparatus of this invention consists of a mold 10 formed generally as a four-sided surround 11 having end sides 12 and 13 and long sides 14 and 15, the mold being shown as rectangular. The sides join at rounded edges 16. It will be understood that the mold could be square or formed from shaped sidewalls into other shapes and could, for example, be formed on an arc or curvature to form different types of blocks of snow or other compatible material.

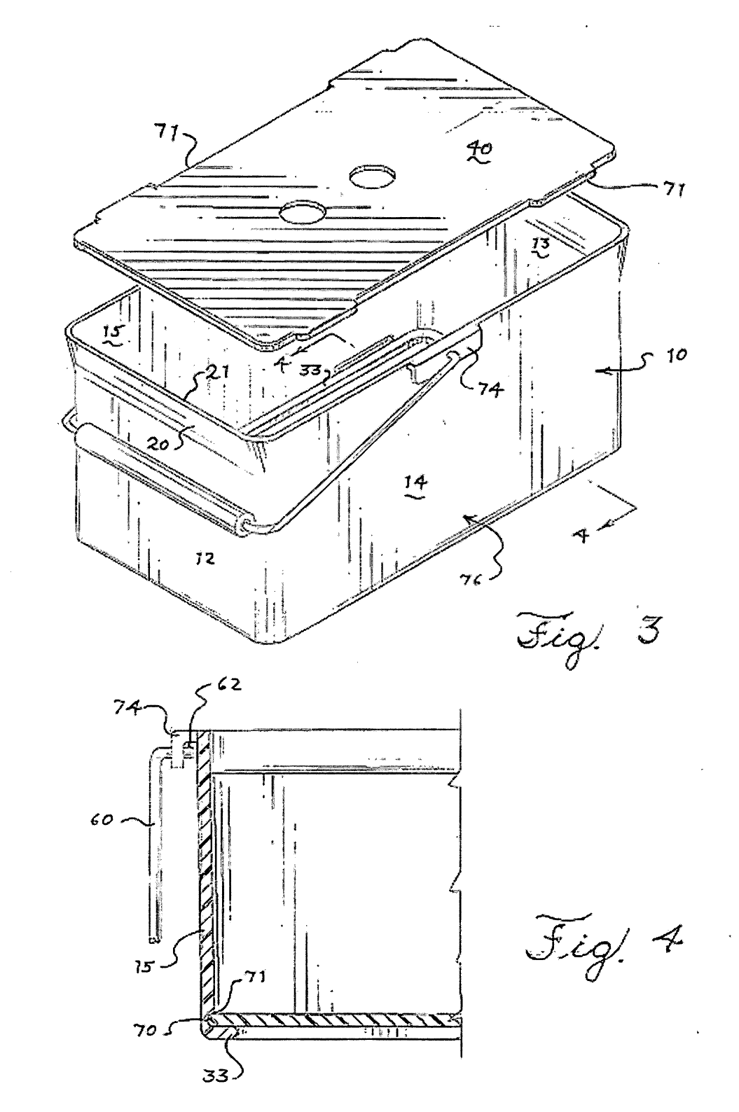

FIG. 2 is an enlarged partial cross-section taken generally along the lines ii-ii of FIG. 1 and illustrates sidewall 14 which is tapered slightly outwardly from an inside corner bottom 18 upwardly to a intermediate point 20 spaced from a top 21 of the wall 14. The wall portion between the intermediate point 20 and the top 21 tapers outwardly at a greater angle than the taper between the bottom corner 18 and the intermediate point 20 so as to form essentially a funneling surface for funneling snow into the main body section 30 of the mold. An inwardly projecting bead 32 is positioned above an in-turned bottom flange 33 by a distance approximately equal to the thickness of a mold plate bottom 40. The mold bottom plate 40 is removable from the mold by snapping it upwardly past the bead and distorting the bottom 40 enough to snap around the bead. The material of the bottom plate 40 is of a plastic having a resiliency sufficient to allow it to snap into position between the bead 32 and the in-turned flange 33 and to snap out of it under pressure pushing it towards the open top 50.

The bead may, as shown in FIG. 1, be substantially continuous extending entirely around the periphery of the mold body 14 or, as shown in FIG. 2, may be intermittent, reducing the amount of force necessary to remove the bottom from the position between the bead and the in-turned bottom flange 33. The bead creates an interference fit with the undistorted shape of the bottom plate 42.

An outer skirt 51 extends downwardly from the top 21 in spaced relation to the walls 12-15 forming an opening 52. Preferably the skirt 51 extends substantially parallel to the lower section of the walls, which, as mentioned above, are slightly outwardly tapered. The skirt can be straight or slightly outwardly tapered itself. The skirt forms a gripping area so that a person, perhaps equipped with mittens or gloves, can grab the mold from around its periphery. Preferably the entire mold is formed of a sufficiently resilient plastic that a child's finger would not get stuck in the space 52. The skirt also allows for a wider top which is preferably not sharp edged.

The skirt 51 can also serve as the attachment point for a bail 60 formed of a generally U-shaped wire member 61, which has hook ends 62 extending through openings 63 in the skirt and being bent into the space 52 so as to resist removal. Although I've shown the mold as utilizing one bail, it can be understood that the mold may have two bails, one closer to the wall 12 and wall closer to the wall 13, the bails being long enough the be brought together over the center of the mold to aid in lifting. The bottom 40 is provided with openings 44 therein, which will allow drainage as the snow is compacted into the mold body 14.

In the preferred embodiment, as shown the openings 44 may be formed as finger holes to allow the bottom to be maneuvered both to snap it into position and to pull it out of position when the mold is empty. Generally, in use of the mold, snow or wet sand or other formable material will be molded into the mold body 14, with the aid of the funnel shape of the top portion of the walls, and with the bottom in place. A second bottom shaped member may also be provided to aid in compacting the material into the mold to approximately the height of the intermediate section 20 of the sidewalls thereby forming generally a rectangular block as shown in the mold embodiment illustrated. The bottom can then be pushed upwardly or, upon inversion of the mold, downwardly, to break loose the compacted formed block by snapping the bottom 40 beyond the bead 32. The tapered wall portions will aid in release of the formed block.

If desired, the inside of the walls may be formed with vertical ribbing or the like to add detail to the formed block or the top and/or bottom surface of the bottom may be provided with a three dimensional feature or indicia, such as the words “snow mold” as illustrated to impress into the molded block, a feature, including advertising, which will then form part of the top of the block as the mold is inverted and the block is pushed out.

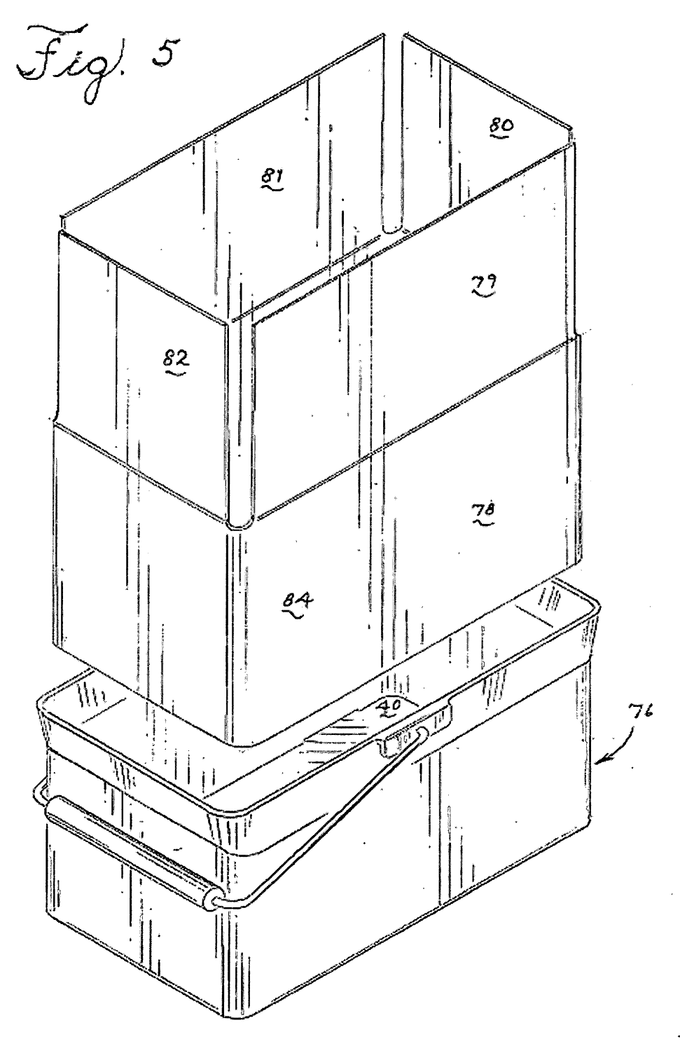

FIGS. 3 and 4 illustrate a variation of the mold 10 formed with long sidewalls 14 and 15 which have blind recesses 70 formed into the sidewalls 14 and 15 immediately above the in turned flange 33. The recesses 70 are spaced apart and are designed to receive projected tabs 71 which project from the sidewalls 40. The tabs 71 and recesses 70 are dimensioned such that as the bottom 40 is pushed against the in turned flange the tabs 71 will snap into the blind recesses. It will be understood that the tabs and the recesses are relatively small in projection and depth respectively so as to allow the bottom to be held in place in the same manner as the beads as FIGS. 1 and 2 without, however, either allowing the bottom to fall out on its own or to require too much force to push it towards the open end of the mold when clearing the contents of the mold.

FIGS. 3 and 4 also show another modification where the sidewalls 14 and 15, although generally tapering outwardly from their bottom to their open top do not then have the downwardly extending skirt 51. The end walls 12 and 13 are provided with the outward taper between the intermediate points 20 and 21 but are not provided with the skirt 51. The sidewalls 14 and 15 are provided with a partial skirt 74 extending outwardly from the top of the sidewalls 14 and 15 at the outside of the mold body. The partial skirts 74 provide a mount for the bail 60 which may have either a straight end projecting through an opening in the skirt 74 or may have the curved end 62 similar to that shown in FIG. 2.

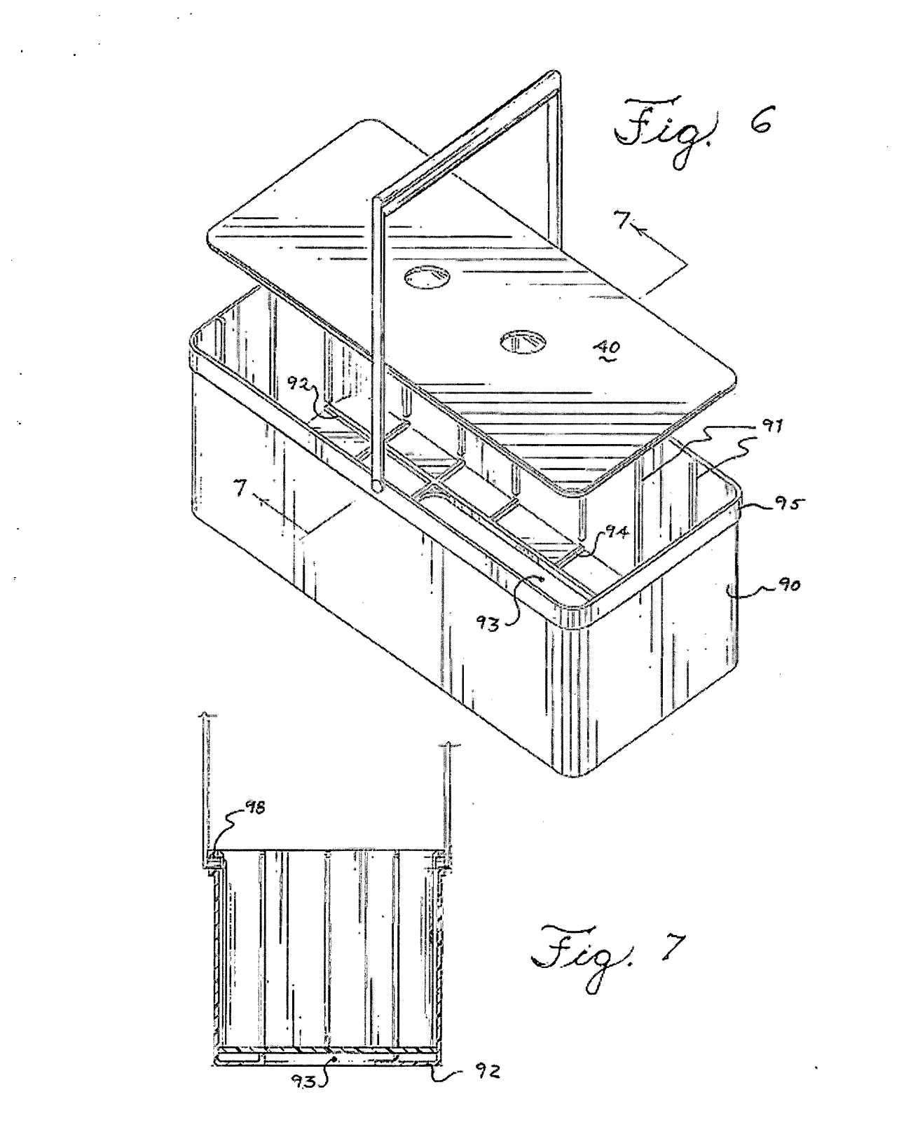

As shown in FIG. 5, the mold 76 may receive a preformed receptacle 78 which may have flaps formed at the upper end to provide a closure of the receptacle after it has been filled. Receipt of this receptacle into the mold will hold the receptacle in shape during filling. The receptacle can then be closed by folding over the flaps. Ideally the flaps will lie at the top of the mold so that the main body section 84 of the receptacle 78 will substantially fill the mold cavity. The mold cavity will hold the container 78 in shape during filling and after the filling has been completed the flaps can be used to close off the top. By then, carrying the mold to the location where it is desired to be deposited to build a structure such as a wall, and then inverting the mold, the flaps of the closed end of the receptacle 78 will lie against the surface, upon which the receptacle 78 is being placed to hold the contents in place.

In such a situation the tapered walls of the mold itself may be sufficient to release the container 78 without removal of the bottom, however since the bottom can be forced out from its snapped in place position, should the material have expanded the receptacle 78 sufficient to bind it in the mold, it is easily ejected by pushing against the bottom while lifting up the mold block.

The receptacle itself can be formed of any material, including plastics, cardboard, paper or similar materials. It is desired that the receptacle be formed of a material that is yieldable or formable sufficiently to allow the receptacle to expand into contact with an adjacent receptacle which has previously been deposited so as to take up the gap left by the sidewalls of the mold as the mold is removed. To this end it is desired that the mold be made of a relatively stronger material, which could be plastic, metal, paper laminate or other materials having sufficient rigidity to carry the contents.

The weight to be transported by the mold will be generally fairly significant expect in the case of molds provided for children's snow forts and like recreational activities. For levies, revetments and military type protection, greater content weight allows both the faster buildup of the structure and provides a stronger structure. For example, a military blast protection structure formed of sand bags should be at least 16 inches in depth front-to-back, to that end a 16×8 inch approximate mold interior allows a 16 inch deep structure to be quickly formed with the long walls of the receptacle 78 placed side-by-side so that the end walls form the front and rear of the structure or conversely with the long walls placed side-by-side the plane intermediate the front and rear where the sidewalls themselves form the front and rear. Preferably the mold body will have a depth of from 6 to 10 inches, a length of from 12 to 20 inches and a height of from 6 to 12 inches. It will be appreciated that the final dimensions will take into consideration the user, i.e. children for a snow mold or adults for a sandbag mold, as well as the use and the weight of the material expected to be used to form the block. Where heavier weights are expected a mold body having two bails may be preferred so long as both bails can be rotated to facilitate ejection of the block. Different layings of the receptacles will be readily understood to those skilled in to the art, and structures are made by the use of the mold are not limited to the 16 inch thickness as many layers front-to-back as desired may be placed.

Generally speaking the material for an 8×16×8 inch tall receptacle filled with sand or dirt may weigh between forty and sixty pounds. Obviously if the sand is wetter the receptacle may weigh more when filled. This requires that the mold body itself be relatively structurally stable and that the bail connection be sufficiently structurally strong so as to not deteriorate or break during usage.

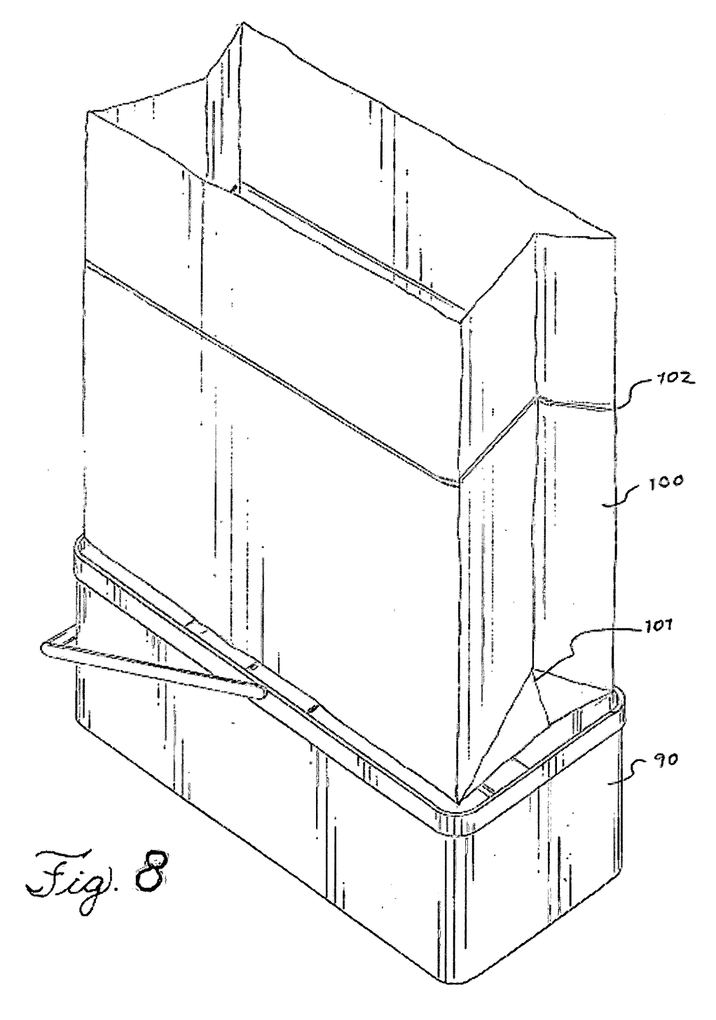

FIGS. 6 and 7 show a further modification of the mold. In this instance the mold body 90 is again formed as a four-sided structure which, as shown, may be generally rectangular and thus conform to the 8×16×8 dimensions discussed above. It will also be understood that other shapes can equally well be provided, for example an 8×8×8 mold body would reduce the weight to be transported, thereby allowing the use of cheaper materials in the forming of the mold body and bottom while reducing the stress on the bail. While such a smaller structure has therefore cost advantages it has a disadvantage in that it delays the time necessary to provide a finished structure or increases the number of workers required.

In the embodiment shown in FIGS. 6 and 7, internal ribbings 91 are provided to strengthen the sidewalls and end walls, and a much more complete bottom through which the removable bottom 40 can be accessed from its underside. This structure allows the removable bottom 40 to be made of a lighter weight material since the majority of the weight of the material in the mold will be supported by the bottom 92 of the mold body 90. The mold bottom 92 may be provided with strengthening ribs 94 against which the bottom 40 will rest. By terminating the ribs 91 short of the bottom ribs 94, the edges of the bottom 40 can snap in under the side ribs. This is a result of the ability to use a more flexible bottom 40 which can better be snapped into position. It will of course be understood that the rib structures 91, 94 can be used with different methods of holding the bottom 40 in place, including the beads 32 of FIG. 1 or the rejections and recesses 70, 71 of FIGS. 3 and 4. In this embodiment the walls of mold body may be formed without the taper as the existence of the vertical ribs 91 will act to reduce adhesion of a receptacle received in the mold. The mold body 90 may be formed with a thickened top section 95 to which the bail 96 may be attached. As shown in FIG. 7 the thickened portion may be provided with through walls and the bail may be provided with in turned pins 38 or rivets which extend through openings in the thickened portion 95. If rivets are used the bail legs 99 may be provided with openings at their ends or adjacent their ends through which headed rivets can be pressed and then distorted on the interior of the thickened portion 95, in which case the thickened portion may be provided with complimentary recess on the interior into which the material of the rivet can be distorted into or peened into.

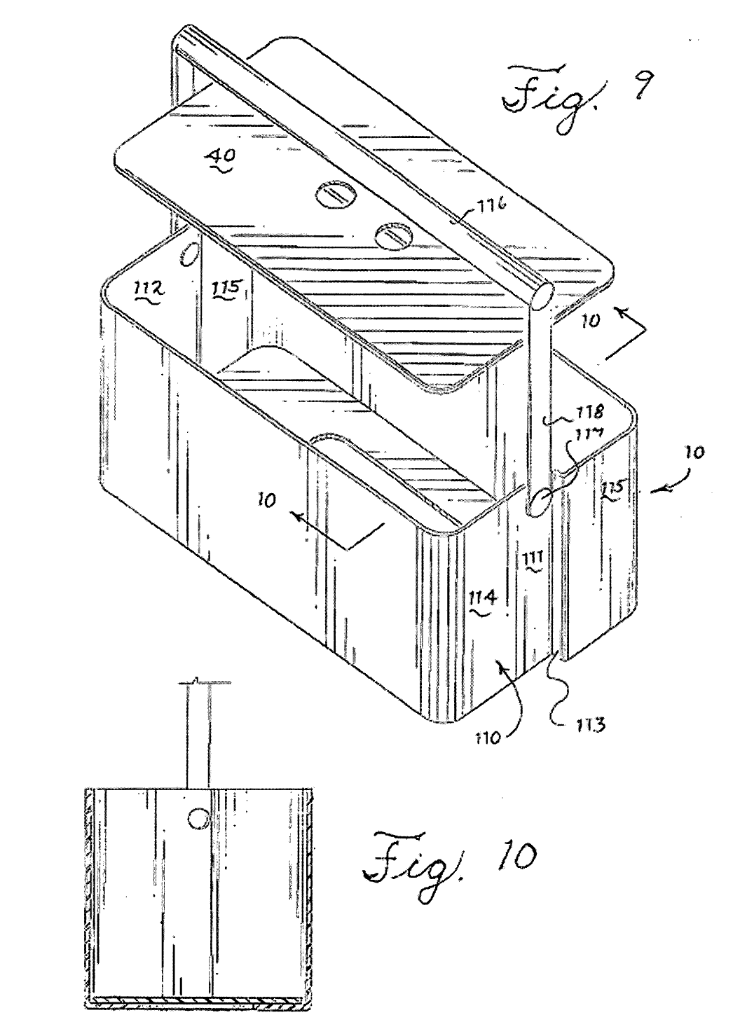

FIG. 8 illustrates the mold body 90 in accordance with FIGS. 6 and 7 receiving a gusseted bag 100. The bag may be gusseted as at 101 at the bottom and may additionally be provided with folding markings 102 along the sidewalls of the bag to allow the bag top to be folded closed. The use of a gusseted bag allows for ease of storage and shipment, whereas the bag when put into the mold and opened fully will hold the contents of the appropriate size for the mold body. Thereafter, folding over the top will enclose the contents so that the resultant filled bag can then be placed into position by inversion of the mold substantially as shown at 105 of FIG. 11, where the bag 100a has been placed adjacent the bag 100b and atop previously laid bags 100c and 100d. As shown in FIG. 11 the mold body 105 may have the bail running from short end to short end rather than from long end to long end as shown in FIG. 8. It is important that the bail be sufficiently long in either manner of attachment so that it can be ideally reversed to allow the mold to be pulled away from the material or the receptacle during the deposit of the receptacle 100a into position.

It will be understood that again it is desired that the bag be sufficiently resilient or yieldable or deformable, so that it will, upon removal of the mold body slightly bulged out to contact with the adjacent previously laid blocks. In the embodiment shown in FIG. 11, the bolting would need to be at least the distance of the thickness of the sidewall plus the distance of the bail legs for at least the portion of the side of the receptacle aligned with the bail legs.

As shown at 107, the blocks or receptacles or bags can be alternating in lengthwise placement or sidewise placement in the same row, or as shown in differing rows, and may be built up in as many rows as desired and as thick as desired front and back. FIG. 11 shows the formation of a corner.

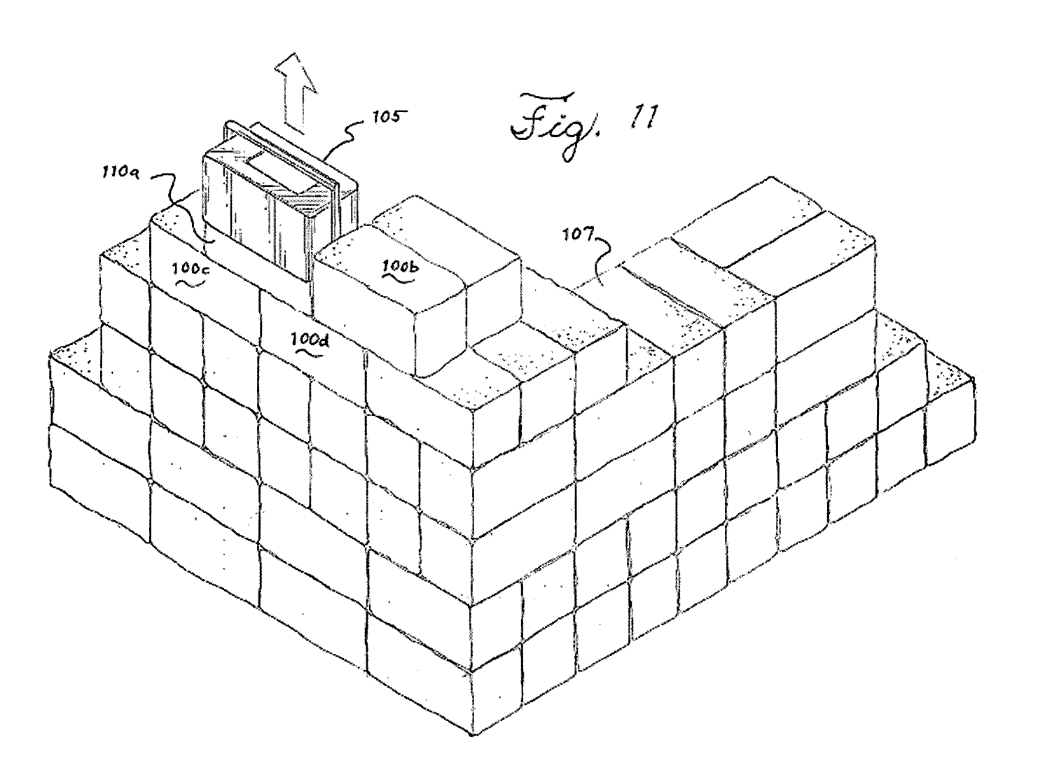

FIGS. 9 and 10 show yet another variation of the mold 10. In this case the mold body 110 has its short end faces 111 and 112 ledged at 113 to form an offset portion 114 which is spaced closer to the other short wall then the non-offset portion 115. This allows the bail 116 to be rotatably affixed, such as at 117, to the recessed portion 114. The recessed portion ideally is the thickness of either the bail leg 118 or of the bail rivet 117 if a rivet is used. The purpose of the offset is to allow the sand bag or other receptacle received in the mold body to have a portion of, corresponding with the area interior of the sections 115 to be filled initially in a shape that will not be compromised in the laying of the thickness of the bail but only by the thickness of the sidewall of the mold body. This allows the use of stronger bails. It will be noted that the bail is of a length where it can then rotate around the pivot all the way to the underside of the mold body and then be used to lift the body while the bottom 40 is pushed by accident through the central opening 93. In this structure the interior strengthening ribs are not shown, however such ribs could be provided if desired. Again, in this structure in tapering the four sidewalls is not illustrated but could be provided if desired.

From the above it will be appreciated that this invention provide an improved block-forming mold for use in compacting snow, wet sand or the like into individual blocks, the mold consisting of an at least four-sided open top and open bottom enclosure with a snap-in, snap-out bottom, which in the snap-in position interacts between a sidewall surface interruption section on an interior wall and an in-turned flange at the bottom of the peripheral walls. A funnel-shaped top section of the peripheral walls can aid in compressing quantities of loose snow or the like into the actual mold forming intermediate section or into receptacle received therein and where tapered walls assist in extraction of the molded block on inversion of the mold form. A peripheral downwardly extending top skirt may provide a gripping feature and a place for affixing the ends of a bail or bails without being projected into the interior mold.

Although I have shown this invention in connection with preferred embodiments, those skilled in the art will understand that it may be practiced in many different designs and variations and manufactured of many different materials and in different shapes.

I claim as my invention:

1. A block forming mold for compactable material such as snow comprising a mold member having at least four peripheral walls connected together at edges to form an enclosure, the enclosure having an open top and an open bottom, at least some of the peripheral walls having in-turned flanges at a bottom thereof, the peripheral walls having raised inwardly extending restraining members formed thereon spaced from the in-turned flange, a removable bottom plate having a top-to-bottom thickness of approximately the same as the distance between the top of the in-turned flange and the retaining members and being snappable into place under the retaining members atop the in-turned flange to form a bottom to the enclosure, the peripheral walls having top portions extending outwardly and upwardly away from each other forming a funnel-like opening to the interior of the enclosure, the peripheral walls terminating in a top, a skirt surrounding the peripheral walls extending downwardly from adjacent the top in spaced relationship to outside edges of the peripheral walls.

2. The mold according to claim 1 wherein the retention members comprise a raised bead formed on the inside surface of the peripheral walls.

3. The mold according to claim 2 wherein the raised bead is formed of a series of spaced apart bead sections.

4. The mold according to claim 2 wherein the peripheral walls extend upwardly and outwardly at a taper from the bead section to an intermediate point and then outwardly at a greater taper whereby the peripheral walls taper outwardly for ease of release of a molded block formed interior of the enclosure.

5. The mold according to claim 4 wherein the bottom has openings therethrough.

6. The mold according to claim 5 wherein the bottom has indicia thereon for forming surface irregularity features in the block being molded.

7. The mold according to claim 6 wherein the indicia are raised.

8. The mold according to claim 7 wherein a bail is attached to the enclosure through openings in the skirt.

9. A mold specifically adapted for compacting blocks of snow comprising a mold enclosure having at least four peripheral sides joined together to form an enclosure having an open top and substantially open bottom, the peripheral sides having in-turned flanges at bottom thereof and inwardly extending projections spaced from a top of the in-turned flange, a bottom forming plate having a thickness not greater than the distance between the top of the in-turned flanges and the bottom of the inward projections and having an overall dimension approximately the same as the interior dimension of the enclosure at the bottom of the peripheral walls whereby the bottom plate can be snapped into position resting on the in-turned flange held from falling out by the in-turned projections, the bottom plate being resilient sufficient to be pushed past the inward projections, the peripheral walls having a first taper from the projection to an intermediate point with the walls extending upwardly and outwardly, a second taper greater than the first taper extending from the intermediate point to a top edge forming a funnel surface for aiding in funneling snow into the mold interior, the bottom plate having drainage openings therethrough.

10. The mold according to claim 9 wherein a peripheral skirt extends downwardly and outwardly from the top spaced from the peripheral walls forming a gap there between, the skirt being integrated to the peripheral walls at the top.

11. The mold according to claim 10 wherein at least one bail is attached to the enclosure through openings in the skirt.

12. The mold according to claim 11 wherein the inward projection constitutes a bead extending substantially around the interior of the enclosure.

13. The mold according to claim 12 wherein the bead is intermittent.

14. A mold specifically adapted for forming bagged blocks of granular material comprising a mold body enclosure having at least four peripheral sides joined together to form an enclosure having an open top and a substantially open bottom, at least some of the peripheral sides having in-turned flanges at bottoms thereof and having surface interruptions cooperating with edge surfaces of a removable bottom insertable through the open top and against the in-turned flanges in an interference fit relationship with the surface interruptions, the bottom being sufficiently resilient to be pushed into a snap fit engagement with the surface interruptions and to thereby be retained against the flanges until a force is applied to the bottom to move it away from the flanges towards the open end, the bottom being sufficiently resilient that the application of said force will overcome the snap fit interference fit allowing the bottom to be moved towards the open top, a sand bag dimensioned to be received within the mold body, the bag having a closed bottom engageable against the bottom when the bottom is in the snap fit retained position and having a periphery extending from the closed bottom dimensioned to substantially fully conform to the dimensions of the enclosure of the mold body and to extend above the open top by a distance sufficient to allow bag to be closed to close off the open top of the bag when the bag has been filled with conformable material to substantially the open top of the mold body, a bail attached to the mold body for carrying the mold body, the bail having a carrying position extending above the mold body and a dispensing position not obstructing the open top of the mold body whereby the contents of the bag can be discharged from the mold with the bag with the bag closure on the bottom of the discharged bag by inversion of the mold.

15. A method of making a sand bag structure which comprises the steps of providing a mold enclosure defined by sidewalls, inserting a sand bag into the mold enclosure in contact with a bottom of the mold enclosure, the sand bag having a periphery engageable with the sidewalls of the mold body upon filling of the sand bag with flowable displaceable material, the bag having a height greater than a height of the mold body terminating in an open end into which the flowable displaceable materials may be inserted, filling the bag to a level approximately adjacent a top of the mold body, closing the open top of the bag, transporting the mold by hand from a place of filling to a place for a structure to be formed of sand bags, inverting the mold at the place for the structure and ejecting the bag from the mold onto a surface with the bag closure lying on the underside of the ejected bag and with the bag maintaining substantially the shape of the mold while being sufficiently yieldable to fill voids between sides of the discharged bag and adjacent structural elements or previously laid bags representing the thickness of the mold body sidewalls and repeating the steps of inserting, filling, closing, transporting, inverting, and ejecting until the structure is complete.

16. A method of making a sandbag block for construction of sandbag structures which comprises the steps of providing a mold body defined by sidewalls, the body having a generally rectangular cross section and an open top and at least a partially open bottom, a removable bottom section insertable into the mold body interior and against in-turned flange portions defined at bottoms of sidewalls of the mold body, cooperating interfering sections between edge portions of the removable body and service interruptions on the internal surfaces of the sidewalls providing a removable snap fit connection between the removable bottom and the sidewalls sufficient to hold the bottom in place above the flanges against accidental dislodgement of the bottom while allowing dislodgement of the bottom intentionally by the application of pressure against the bottom lifting it towards the open top of the mold body, a separate receptacle insertable into the mold body which is generally conformable to the dimensions of the interior of the mold body when filled with material, the receptacle having an open top extending above the mold body a sufficient distance to allow the receptacle's open end to be closed at a height approximately level to the top of the receptacle body after filling the receptacle with sandbag filling material, with the receptacle being ejectable from the mold body upon inversion of the mold body after closure of the receptacle top whereby the closed top will align on a bottom of the sandbag block.

17. The method of claim 16 wherein the receptacle is a sandbag and the material is sand.

18. The method of claim 17 where the dimensions of mold body interior are approximately 8 inches deep×16 inches×long×8 inches in height.

19. The method of claim 18 where in the receptacle is formed of a yieldable bag material which is gusseted to fold flat for storage and shipment.

20. The method of claim 17 wherein the receptacle is a sandbag and the material is one or a mixture of both of dirt or gravel.

21. The method of claim 16 wherein the dimension of the mold body interior are from 6 to 10 inches in depth, 12 to 20 inches in length and 6 to 12 inches in height.
